(19) United States
(12) Patent Application Publication
(10) Pub. No.: US 2013/0249279 A1
(43) Pub. Date: Sep. 26, 2013

(54) IN-VEHICLE ELECTRONIC DEVICE

(71) Applicant: DENSO CORPORATION, Kariya-city (JP)

(72) Inventor: Haruhiko SOGABE, Kariya-city (JP)

(73) Assignee: DENSO CORPORATION, Kariya-city (JP)

(21) Appl. No.: 13/788,072

(22) Filed: Mar. 7, 2013

(30) Foreign Application Priority Data
Mar. 26, 2012 (JP) 2012-69407

(51) Int. Cl. B60R 16/03

(52) U.S. Cl. CPC B60R 16/03
USPC 307/9.1

(57) ABSTRACT

An in-vehicle electronic device includes a power circuit, a control portion, an external input portion, and a control input portion. The power circuit supplies power when a signal transmitted to a control terminal is in a specified state in a state where an input terminal is coupled with a power source. The control portion operates by receiving the power supplied from the power circuit. The external input portion transmits an external signal from outside to the control terminal of the power circuit and the control portion. The external signal includes an activation signal and a power supply request signal. The control portion performs a temporary operation based on a power supply voltage applied in accordance with the activation signal and continuously transmits a control signal in a specified state based on the power supply request signal.

### CROSS REFERENCE TO RELATED APPLICATIONS

The present application is based on and claims priority to Japanese Patent Application No. 2012-69407 filed on Mar. 26, 2012, the contents of which are incorporated in their entirety herein by reference.

### TECHNICAL FIELD

The present disclosure relates to an in-vehicle electronic device including a power circuit having a control terminal.

### BACKGROUND

An in-vehicle electronic device mounted in a vehicle, such as a car and a motorbike, operates by receiving a power supply from an in-vehicle battery. For example, the in-vehicle electronic device includes a theft tracking device. When a vehicle is manufactured, eventually a battery is coupled and inspections are performed. A completed vehicle is shipped from a manufacturing plant and is transported to a dealer. It may take a long term from when the vehicle is shipped from the manufacturing plant to when the vehicle is delivered up to a user via a dealer due to, for example, a transportation using a ship. After the vehicle is sold to a user, the user may store the vehicle for a long term because the user does not use the vehicle for the long term.

As long as the in-vehicle electronic device is physically coupled with the in-vehicle battery, a small power consumption continues. Thus, if a time for which the vehicle does not run (transportation time and storage time) is long, a battery level decreases, and the battery may be dead at worst. Thus, in order to restrict exhaustion of the in-vehicle battery, a vehicle manufacture needs to ship the vehicle after physically decoupling the in-vehicle electronic device from the in-vehicle battery.

Japanese Patent No. 3,217,730 (corresponding to U.S. Pat. No. 5,892,893) discloses a configuration in which a function of determining a predetermined term (sleep operation and normal operation) and a control terminal (ENA/NINH) for controlling a power circuit are provided in a communication circuit for communicating with an external device. According to this configuration, supply and stop of power are automatically controlled without physically decoupling an in-vehicle electronic device and an in-vehicle battery.

However, in the configuration described in Japanese Patent No. 3,217,730, if the communication circuit (communication IC) malfunctions, the function for determining the predetermined term may be lost. Thus, the configuration does not include means for recovering from, for example, the sleep mode. In addition, a software design for controlling the communication circuit is needed. Furthermore, a function, such as a control terminal for controlling the power circuit, needs to be added to the communication circuit, and the communication circuit needs to be configured as a specialized IC. Digitalization is proceeding in general-purpose communication ICs, and many of general-purpose communication ICs do not include a control terminal to be coupled with an analog processing circuit, such as a power circuit. Thus, an IC including a control terminal is more expensive than an IC without a control terminal.

### SUMMARY

It is an object of the present disclosure to provide an in-vehicle electronic device in which a control portion can be activated by an external device.

An in-vehicle electronic device according to an aspect of the present disclosure includes a power circuit, a control portion, an external input portion, and a control input portion. The power circuit has an input terminal and a control terminal. The power circuit supplies power when a signal transmitted to the control terminal is in a specified state in a state where the input terminal is coupled with a power source. The control portion operates by receiving the power supplied from the power circuit. The external input portion transmits an external signal from outside to the control terminal of the power circuit and the control portion. The control input portion transmits a control signal from the control portion to the control terminal of the power circuit. The external signal includes an activation signal in the specified state and a power supply request signal requesting a steady supply of the power as necessary. The control portion performs a temporary operation based on a power supply voltage applied in accordance with the activation signal and continuously transmits the control signal in the specified state based on the power supply request signal.

When the external signal is transmitted through the external input portion, the activation signal in the specified state is transmitted to the control terminal of the power circuit and the power circuit supplies the power to the control portion. Upon receiving the power supply, the control portion performs the temporary operation and continuously transmits the control signal to the control terminal of the power circuit through the control input portion. As a result, the control portion can be activated from outside.

### BRIEF DESCRIPTION OF THE DRAWINGS

Additional objects and advantages of the present disclosure will be more readily apparent from the following detailed description when taken together with the accompanying drawings. In the drawings:

FIG. 1 is a diagram showing a theft tracking device according to an embodiment of the present disclosure;

FIG. 2 is a flowchart showing a control circuit activation process; and

FIG. 3 is a timing diagram at a time when an external signal is input.

### DETAILED DESCRIPTION

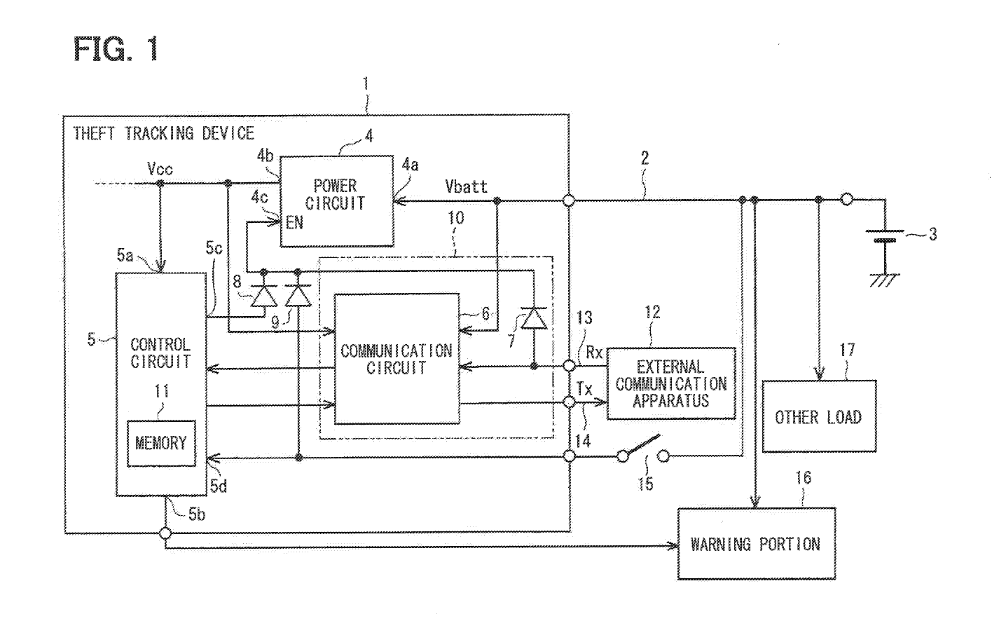

An embodiment of the present disclosure will be described with reference to the drawings. A theft tracking device 1 shown in FIG. 1 is an in-vehicle electronic device mounted on a vehicle, such as a car and a motorbike. The theft tracking device 1 executes a theft tracking process on condition that an operation mode relating to a control circuit activation process is in a normal mode in a state where an in-vehicle battery 3 is coupled with a power supply line 2.

The theft tracking device 1 includes a power circuit 4, a control circuit 5, a communication circuit 6, diodes 7, 8, 9, and other circuit elements (not shown). The communication circuit 6 and the diode 7 are included in an external input portion 10. The control circuit 5 can operate as a control portion, and the diode 7 can operate as a detection circuit. The diodes 8, 9 can operate as a control input portion, and a switch input portion, respectively. The circuit elements include an acceleration sensor, a wireless communication device, and a global positioning system (GPS) receiver. The acceleration sensor detects acceleration in a front-rear direction, a vertical direction, and a right-left direction of the vehicle. The wireless communication device is connectable with a mobile telephone network, The GPS receiver receives a radio wave transmitted from a GPS satellite to detect a current position of the vehicle.

The power circuit 4 includes an input terminal 4a, an output terminal 4b, and an EN terminal 4c. When the battery 3 is coupled to the power supply line 2, the input terminal 4a is applied with a battery voltage Vbatt (e.g., 12V). The EN terminal 4c is a control terminal to enable or disable a power supply operation of the power circuit 4. The EN terminal 4c receives an external signal, a control signal, and a switch signal through the diodes 7, 8, 9, respectively. The power circuit 4 stops the power supply operation when a signal at L-level (e.g., 0V) is input to the EN terminal 4c. On the other hand, when a signal at H-level (Vcc; 3.3 V or Vbatt; 12V) corresponding to a specified state is input to the EN terminal 4c, the power circuit 4 generates a power supply voltage Vcc from the battery voltage Vbatt and transmits the power supply voltage Vcc from the output terminal 4b.

The control circuit 5 includes a microcomputer. The control circuit 5 is activated when the power circuit 4 supplies the power supply voltage Vcc to a power terminal 5a. The microcomputer includes a rewritable nonvolatile memory 11, such as an electrically erasable programmable read-only memory (EEPROM) and a flash memory, a central processing unit (CPU), a random access memory (RAM), a read only memory (ROM), and an input-output interface, which are not shown. The control circuit 5 executes the theft tracking process and the control circuit activation process based on control programs stored in the memory 11 or the ROM. In the control circuit activation process, the control circuit 5 transmits the control signal temporarily or continuously from the control terminal 5c to the EN terminal 4c of the power circuit 4 through the diode 8.

The theft tracking device 1 is connectable with an external communication apparatus 12, such as a communication apparatus for diagnosis. The communication circuit 6 is a general-purpose serial communication circuit coupled between the control circuit 5 and the external communication apparatus 12. When the communication circuit 6 receives the power supply from the power circuit 4, the communication circuit 6 becomes communicatable with the external communication apparatus 12 through a communication line 13 (Rx) for reception and communication line 14 (Tx) for transmission.

Because a signal voltage level (Vbatt) between the communication circuit 6 and the external communication apparatus 12 is different from a signal voltage level (Vcc) between the communication circuit 6 and the control circuit 5, the communication circuit 6 receives the battery voltage Vbatt required for a level shift process. Because the communication circuit 6 is formed as a general-purpose communication circuit chip, a cost of the communication circuit 6 is low. The diode 7 is coupled between the communication line 14 and the EN terminal 4c of the power circuit 4.

The vehicle includes an ignition switch 15. One terminal of the ignition switch 15 is coupled with the power supply line 2, and the other terminal of the ignition switch 15 is coupled with an input terminal 5d of the control circuit 5. The diode 9 is coupled between the other terminal of the ignition switch 14 and the EN terminal 4c of the power circuit 4. The diodes 7, 8, 9 are coupled in OR connection in which cathodes are coupled in common. The cathodes coupled in common are coupled with the EN terminal 4c of the power circuit 4.

The vehicle further includes a warning portion 16 and other electric and electronic loads which operate by receiving the power supply from the battery 3 through the power supply line 2. The warning portion 16 includes a horn and a hazard lamp. The electric and electronic loads include an electronic control unit (ECU), a lamp, an audio device, a motor, and a solenoid. The warning portion 16 is also activated by a driving signal transmitted from an output terminal 5b of the control circuit 5.

The theft tracking device 1 having the above-described configuration executes the theft tracking process based on the control program. When the accelerations in the three axial directions detected by the acceleration sensor exceed predetermined threshold values, the control circuit 5 detects that the vehicle is inclined abnormally or the vehicle is subject to impact. Then, the control circuit 5 determines that a theft of the vehicle occurs, taking into consideration detection values of other vehicle states. When the control circuit 5 determines that a theft of the vehicle occurs, the control circuit 5 transmits the driving signal to the warning portion to inform the surrounding people of the occurrence of the theft aurally or visually.

The control circuit 5 calculates a position data of the vehicle based on the signal received by the GPS receiver and periodically transmits the position data to a mobile phone of a user or a communication device installed in a service center using the wireless communication device. A secondary battery may be disposed in the theft tracking device 1 so that a the theft tacking device can operate even when the power supply line 2 between the theft tracking device 1 and the in-vehicle battery 3 is disconnected.

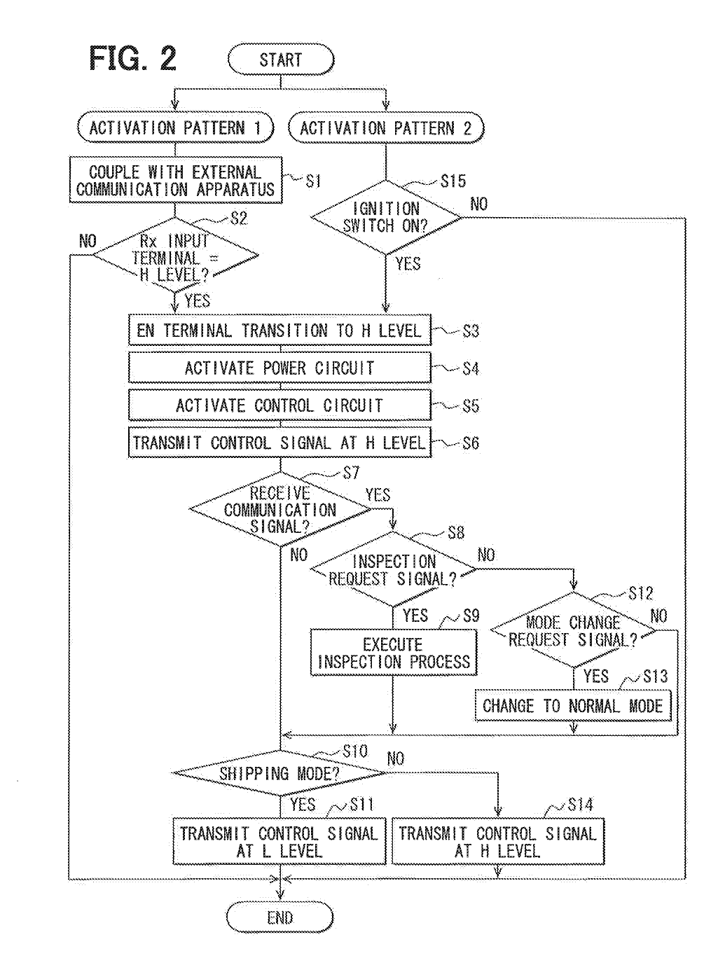

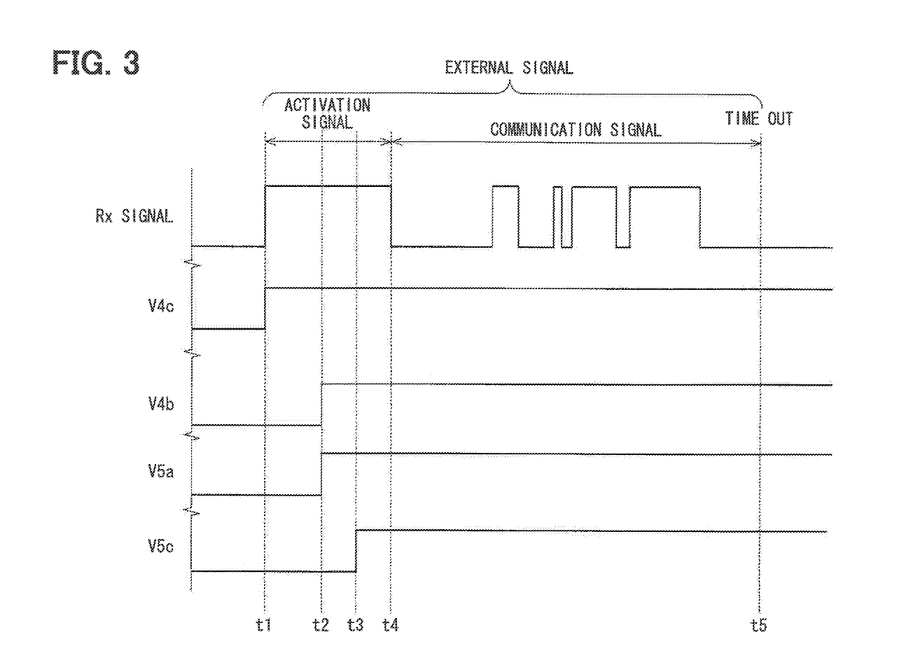

Next, the control circuit activation process of the theft tracking device 1 will be described with reference to FIG. 2 and FIG. 3. In the control circuit activation process, the power circuit 4 starts the power supply operation to activate the control circuit 5 in response to the external signal transmitted from the external communication apparatus 12 or the switch signal transmitted from the ignition switch 15.

When the battery 3 is coupled to the vehicle in a manufacturing plant and the vehicle is shipped, the power supply operation is stopped (shipping mode). Then, when the vehicle is delivered up to a dealer or a user, the power supply operation is started using the external communication apparatus 12 (normal mode). After transition to the normal mode, when a user couples the battery 3 again after the user decouples the battery 3 and the vehicle is stored for a long term, the user can start the power supply operation using the ignition switch 15.

FIG. 2 shows an overall sequence relating to the control circuit activation process, such as operation by the dealer and the user, the process of the control circuit 5, and operation of the power circuit 4. FIG. 3 is a timing diagram of the external signal (Rx signal) transmitted from the external communication apparatus 12, the voltage (V4c) of the EN terminal 4c of the power circuit 4, the voltage (V4b) of the output terminal 4b of the power circuit 4, the voltage (V5a) of the power terminal 5a of the control circuit 5, and the voltage (V5c) of the control terminal 5c of the control circuit 5.

The control circuit 5 includes two operation modes, that is, the normal mode and the shipping mode, for appropriately executing the control circuit activation process. The operation modes are stored in the memory 11. An initial mode at a time when the theft tracking device 1 is manufactured in the manufacturing plant is set to the shipping mode. In the shipping mode, the power supply to an internal circuit (the control circuit 5, the communication circuit 6, and the like) in the theft tracking device 1 is stopped, and a consumption current of the battery 3 is reduced as much as possible.

In the normal mode, the power supply to the internal circuit in the theft tracking device 1 is performed, and functions necessary to a user, such a theft tracking function, is available. After transition from the shipping mode to the normal mode, the theft tracking device 1 does not transition to the shipping mode (not necessary). In cases where the theft tracking device 1 includes the secondary battery, the theft tracking device 1 may enable and disable a charge and discharge operation of the secondary battery with on and off of the power supply from the power circuit 4 in accordance with the operation mode. Operation at each case will be described below.

(I) A case where the vehicle is shipped from the manufacturing plant through inspections (activation pattern 1)

Before the vehicle is shipped from the manufacturing plant, pre-shipping inspections of whether the control circuit 5 can normally communicate and the like are performed. At S1, an operator couples the external communication apparatus 12 to the theft tracking device 1 to transmit the external signal shown in FIG. 3 from the external communication apparatus 12 to the theft tracking device 1. The external signal firstly has an activation signal at the H level (the battery voltage Vbatt) and then has a communication signal including an inspection request signal.

When the external signal includes the activation signal, the communication line 13 (Rx input terminal) transitions to the H level (S2: YES), and the EN terminal 4c of the power circuit 4 transitions to the H level through the diode 7 (S3, time t1 in FIG. 3). After the elapse of about 10 msec from time t1, the power circuit 4 can transmit the stable power supply voltage Vcc (S4, time t2). The stabilizing time changes from a few msec to a few dozen msec depending on the power circuit 4 which is applied. By the power supply, the control circuit 5 is activated and performs a temporary operation (S5).

Processes at S6 and after are executed by the control circuit 5. The control circuit 5 temporarily transmits the control signal at the H level (Vcc) from the control terminal 5c (S6, time t3). After that, in a period in which the control circuit 5 transmits the control signal at the H level, the power supply is continued even after time t4 at which the activation signal of the external signal ends. In other words, the temporary operation by the control circuit 5 is an operation until the level of the control signal is fixed at S11, S15 in accordance with the operation mode.

As described above, it takes about 10 msec (=t2−t1) from when the activation signal transitions to the H level to when the power circuit 4 transmits the stable power supply voltage Vcc. In addition, it takes about 5 msec (=t3−t2) for the stabilizing time of an oscillator and a software process from when the control circuit 5 is supplied with the power to when the control circuit transmits the control signal at the H level. Thus, the activation signal has duration (=t4−t1) longer than or equal to a sum (=t3−t1) of the stabilizing time of the power circuit 4 and the processing time of the control circuit 5. For example, the activation signal has duration of about 20 msec.

Next, the control circuit 5 receives the communication signal, such as an inspection request and a mode change request, transmitted through the communication circuit 6. A time required for the reception of the communication signal is predetermined based on a communication state and a data length of the communication signal. After the elapse of the reception time, the control circuit 5 executes a time out process for determining whether the control circuit 5 receives the communication signal within the reception time (S7, time t5). If the control circuit 5 receives the inspection request signal, the control circuit 5 determines that the control circuit 5 receives the communication signal (S7: YES) and proceeds to S8. At S8, the control circuit 5 determines whether the communication signal is the inspection request signal. When the communication signal is the inspection signal (S8: YES), the control circuit 5 proceeds to S9. At S9, the control circuit 5 executes a predetermined inspection process. After the inspection process, the control circuit 5 transmits an inspection result.

When the communication signal determination process ends, the control circuit 5 determines whether the operation mode stored in the memory 11 is shipping mode (S10). When the communication signal is the inspection request signal, the operation mode does not change, Thus, the control circuit 5 determines that the operation mode is the shipping mode (S10: YES) and proceeds to S11. At S11, the control circuit 5 transmits the control signal at the L level from the control terminal 5c to stop the power supply from the power circuit 4. In cases where the theft tracking device 1 includes the secondary battery, the control circuit 5 disables the charge and discharge operation of the secondary battery.

The external signal has already at the L level, the voltage level of the EN terminal 4c of the power circuit 4 transitions to the L level, and the power circuit 4 stops the power supply. A vehicle manufacturer ships the vehicle in this state. As a result, even after a long-term transportation and a long-term storage at a storehouse of the dealer, exhaustion of the battery 3 can be restricted.

(II) A case where the vehicle is delivered up to the dealer and eventually to the user after the long-term transportation (activation pattern 1)

An operator of the dealer couples the external communication apparatus 12 to the theft tracking device 1 (S1). Then, the external signal including the mode change request signal from the shipping mode to the normal mode is transmitted from the external communication apparatus 12 to the theft tracking device 1. Because the processes from S1 to S7 are similar to the processes described in the case (I), the description of the processes from S1 to S7 is omitted.

At S8, the control circuit 5 determines that the communication signal is not the inspection request signal (S8: NO), and proceeds to S12. At S12, the control circuit 5 determines whether the communication signal is the mode change request signal. When the communication signal is the mode change request signal (S12: YES), the control circuit 5 proceeds to 313 and change the operation mode stored in the memory 11 from the shipping mode to the normal mode. When the communication signal is not the mode change request signal, for example, when the communication signal is not received properly, the control circuit 5 skips S13 and proceeds to S10.

After the communication signal determination process ends, the control circuit 5 determines whether the operation mode stored in the memory 11 is the shipping mode (S10). Because the operation mode has been changed to the normal mode, the control circuit 5 determines that the operation mode is not the shipping mode (S10: NO) and proceeds to S14. At S14, the control circuit 5 continuously transmits the control signal at the H level from the control terminal 5c to steadily supply the power. In cases where the theft tracking device 1 includes the secondary battery, the control circuit 5 enables the charge and discharge operation of the secondary battery. Accordingly, the voltage level of the EN terminal 4c of the power circuit 4 transitions to the H level, and the power circuit 4 continues the power supply until the battery 3 is decoupled. As a result, the theft tracking device 1 can continuously execute the theft tracking process.

(III) A case where the user decouples the battery 3 and stores the vehicle for a long term (activation pattern 2)

The user of the vehicle, especially the motorbike, may decouple the battery 3 for restricting exhaustion of the battery 3 when the user stores the vehicle for the long term without use. The operation mode at the time is the normal mode. In cases where the theft tracking device 1 includes the secondary battery, the theft tracking device 1 operates in the normal mode until the secondary battery is exhausted.

When the user couples the battery 3 again after the long-term storage, the battery voltage Vbatt is applied to the input terminal 4a of the power circuit 4 through the power supply line 2. However, because the EN terminal 4c of the power circuit 4 remains at the L level, the power supply is not performed. Because the user does not have the external communication apparatus 12, the control circuit activation process cannot be executed using the external communication apparatus 12. Thus, by turning on the ignition switch 15, the control circuit activation process is executed. The user may turn on the ignition switch 15 when the user starts up the motorbike.

When the ignition switch 15 is turned on (S15: YES), the EN terminal 4c of the power circuit 4 transitions to the H level through the diode 9 (S3). Accordingly, the power circuit 4 is activated (S4) and the control circuit 5 is activated (S5). The control circuit 5 transmits the control signal at the H level from the control terminal 5c (S6). When the control circuit 5 is activated using the ignition switch 15, there is no communication signal. Thus, the control circuit 5 determines that there is not communication signal (S7: NO) and proceeds to S10. The operation mode has been changed to the normal mode at a time when the vehicle is delivered up to the dealer or the user, the control circuit 5 determines that the operation mode is not the shipping mode (S10: NO) and proceeds to S14. At S14, the control circuit 5 transmits the control signal at the H level for steadily supply power in a manner similar to the process described in the case (II). In cases where the theft tracking device 1 includes the secondary battery, the control circuit 5 enables the charge and discharge operation of the secondary battery. Accordingly, the voltage level of the EN terminal 4c of the power circuit 4 transitions to the H level and the power circuit 4 continuously supply power. As a result, the theft tracking device 1 can execute the theft tracking process.

As described above, the theft tracking device 1 according to the present embodiment can use the normal mode in which the internal power supply is stopped and the normal mode in which the internal power supply is continuously performed. The vehicle is shipped in the shipping mode, and the operation mode is changed to the normal mode when the vehicle is delivered up to the dealer or the user after the long-term transportation. Accordingly, the battery 3 needs no to be decoupled and coupled again, the power consumption of the theft tracking device 1 in the long-term transportation can be reduced, and exhaustion of the battery 3 can be restricted. Accordingly, the battery 3 can be restricted from being dead.

In cases where the theft tracking device 1 includes the secondary battery, exhaustion of the secondary battery can be restricted by disabling the charge and discharge operation of the secondary battery in the shipping mode. In the theft tracking device 1 in which the control circuit 5 and the power circuit 4 are integrally sealed in a casing body, it is difficult to couple the secondary battery again. Thus, the above-described configuration is effective.

When the external communication apparatus 12 is coupled with the theft tracking device 1 and the external signal is transmitted to the theft tracking device 1, the external signal is directly input to the EN terminal 4c of the power circuit 4 through the diode 7 without through the communication circuit 6. Because the external signal includes the activation signal at the H level, the power circuit 4 can be recovered from the power supply stop state to the power supply state.

When the control circuit 5 receives the power supply, the control circuit 5 transmits the control signal at the H level in the temporary operation. In the temporary operation, because the control circuit 5 can receive the mode change request signal through the communication circuit 6, the operation mode can be changed from the shipping mode to the normal mode. When the above-described activation process sequence of the control circuit 5 is activated, a series of flow from shipping from the manufacturing plant to waking up at the dealer is not interrupted. Thus, an additional work, such as decoupling the battery 3, is not needed and workability can be improved.

Many of general-purpose communication ICs do not include a control terminal to be coupled with an analog processing circuit, such as a power circuit. The communication circuit 6 according to the present embodiment needs not a control terminal to be coupled with the power circuit 4. Thus, a general-purpose communication IC can be used as the communication circuit 6. Furthermore, by using the general-purpose communication IC, software for controlling power supply through a specialized communication IC is not needed. Thus, hardware and software of the theft tracking device 1 including the general-purpose communication IC and diodes 7, 8, 9 can be made at a lower cost than a conventional theft tracking device 1 including a specialized communication IC having a control terminal.

After the operation mode is changed to the normal mode and the vehicle is delivered up to the user, the user may decouple the battery 3 for the long-term storage of the vehicle (especially the motorbike). The user does not have means (external communication apparatus 12) for accessing the communication circuit 6. When the user uses the vehicle again, the user only needs to couple the battery 3 and turn on the ignition switch 15. Accordingly, the switch signal at the H level is directly transmitted to the EN terminal 4c of the power circuit 4 through the diode 9 without through the communication circuit 6, and the power circuit 4 becomes the power supply state. According to this configuration, the power circuit 4 can be recovered even when the communication circuit 6 malfunctions. Even when the battery 3 is decoupled and is coupled again, the theft tracking operation can be started in the normal mode without using the external communication apparatus 12.

Although the present disclosure has been fully described in connection with the exemplary embodiments thereof with reference to the accompanying drawings, it is to be noted that various changes and modifications will become apparent to those skilled in the art. The present disclosure may be applied to any in-vehicle electronic device that includes a power circuit 4 having an EN terminal 4c and an external input portion that can input an external signal from outside to the EN terminal 4c and a control portion.

A resistance voltage dividing circuit, an inverter, and a zener diode may be coupled between the diode 7 and the EN terminal 4c in accordance with an input voltage range of the EN terminal 4c of the power circuit 4 and an active level (logic). These components for forming the external input portion are general-purpose components and are inexpensive. After the operation mode is changed to the normal mode, when the battery 3 is decoupled and is coupled again, the theft tracking operation can be started by inputting the external signal from the external communication apparatus 12. The external signal in this case needs to include only the activation signal and needs not include the mode change request signal.

The diode 9, which functions as the switching input portion, may be provided as necessary. The diode 9 may receive a switch signal from a switch instead of the switch signal from the ignition switch. The communication signal may include various request signals different from the inspection request signal and the mode change request signal. A communication line between the communication circuit 6 and an external circuit may be one way.

What is claimed is:

1. An in-vehicle electronic device comprising:
a power circuit having an input terminal and a control terminal, the power circuit supplying power when a signal transmitted to the control terminal is in a specified state in a state where the input terminal is coupled with a power source;
a control portion operating by receiving the power supplied from the power circuit;
an external input portion transmitting an external signal from outside to the control terminal of the power circuit and the control portion; and
a control input portion transmitting a control signal from the control portion to the control terminal of the power circuit,
wherein the external signal includes an activation signal in the specified state and a power supply request signal requesting a steady supply of the power as necessary, and
wherein the control portion performs a temporary operation based on a power supply voltage applied in accordance with the activation signal and continuously transmits the control signal in the specified state based on the power supply request signal.

2. The in-vehicle electronic device according to claim 1,
wherein, in the temporary operation, the control portion temporarily transmitting the control signal in the specified state.

3. The in-vehicle electronic device according to claim 1,
wherein the control portion operates in an operation mode including a normal mode in which the control portion continuously transmits the control signal in the specified state and a shipping mode in which the control signal is not in the specified state, and
wherein the operation mode transitions to the normal mode on condition that the external signal includes the power supply request signal.

4. The in-vehicle electronic device according to claim 3, further comprising
a nonvolatile memory being rewritable and storing the operation mode including the normal mode and the shipping mode, and
wherein when the control portion transitions to the normal mode in the temporary operation, the control portion rewrites the operation mode stored in the nonvolatile memory to the normal mode and operates based on the operation mode stored in the nonvolatile memory.

5. The in-vehicle electronic device according to claim 4, further comprising
a switch input portion transmitting a switch signal in the specified state from an external switch to the control terminal of the power circuit.

6. The in-vehicle electronic device according to claim 5, wherein
the external switch includes an ignition switch.

7. The in-vehicle electronic device according to claim 5, wherein
the switch input portion includes a diode.

8. The in-vehicle electronic device according to claim 1,
wherein the external input portion includes a communication circuit and a detection circuit,
wherein the communication circuit operates by receiving the power supplied from the power circuit, receives the external signal transmitted through a communication line, and transmits the external signal to the control portion, and
wherein the detection circuit detects the external signal transmitted through the communication line and transmits the external signal to the communication terminal of the power circuit.

9. The in-vehicle electronic device according to claim 8,
wherein each of the detection circuit and the control input portion includes a diode.

10. The in-vehicle electronic device according to claim 1,
wherein the activation signal has a duration that is longer than or equal to a sum of a time required for stabilizing an operation of the power circuit and a time required for the control portion to temporarily transmit the control signal in the specified state to the control terminal of the power circuit.

11. The in-vehicle electronic device according to claim 1,
wherein the external signal includes an inspection request signal as necessary, and
wherein, in the temporary operation, the control portion performs an inspection based on the inspection request signal.

12. The in-vehicle electronic device according to claim 1 configured as a theft tracking device of a vehicle.
